(19) United States
(12) Patent Application Publication
(10) Pub. No.: US 2022/0027873 A1
(43) Pub. Date: Jan. 27, 2022

(54) PEER-TO-PEER (P2P) PAYMENT WITH SECURITY PROTECTION FOR PAYEE

(71) Applicant: Capital One Services, LLC, McLean, VA (US)

(72) Inventors: Sai PATHURI, New York, NY (US); Harrison FESEL, Reston, VA (US); Sreenivasa Chandrasekhar NARASINGOLU, Garnet Valley, PA (US); Justin PINSKY, Philadelphia, PA (US); Rajeev KRISHNAN, Chester Springs, PA (US); Fnu Sushil KUMAR, Middletown, DE (US)

(73) Assignee: Capital One Services, LLC, McLean, VA (US)

(21) Appl. No.: 16/938,434

(22) Filed: Jul. 24, 2020

(51) Int. Cl. G06Q 20/10; G06F 9/54; G06Q 20/22; G06Q 20/42; G06Q 20/40; G06Q 40/02; G06Q 20/08; G06Q 20/02; G06Q 20/12; G06Q 20/32; G06K 19/06; G06K 7/14; H04L 29/08

(52) U.S. Cl. CPC G06Q 20/108; H04L 67/104; G06Q 20/223; G06Q 20/42; G06Q 20/4014; G06Q 40/02; G06Q 20/0855; G06Q 20/023; G06Q 20/407; G06Q 20/12; G06Q 20/3274; G06Q 20/3276; G06K 19/06037; G06K 7/1417; G06F 9/547

(57) ABSTRACT

System, apparatus, device, method and/or computer program product are disclosed for making a payment by a customer to a merchant using a peer-to-peer (P2P) payment identification of the customer for a commercial transaction between the merchant and the customer. Embodiments herein provide security protection to the merchant by not revealing a P2P payment identification of the merchant to the customer. A payment request including a customer-facing merchant identification to identify the merchant to the customer is sent to the customer, where the customer-facing merchant identification is different from the P2P payment identification of the merchant. The system is further integrated with a merchant server and the P2P payment system to fulfill the payment to the merchant, to track a status of the payment request, and to determine a status of the commercial transaction between the merchant and the customer.

### BACKGROUND

Transferring money or making a payment from one party to another is an essential part of everyday life. Payment can be made in various ways, e.g., cash, checks, charge cards, credit cards, debit cards, prepaid cards, wire transfer, or other electronic transfers. The Internet revolution has brought many electronic payment systems, e.g., Zelle®, PayPal®, Venmo®, or other electronic payment systems. Today, it is possible to use a variety of apps on a smartphone or browser to electronically transfer money to, or receive money from, personal accounts, including checking accounts, debit cards, and credit cards.

Despite the relative ease of the electronic money transfer process compared to using cash, check, or credit card, there is still room for improvement in convenience and security for making payments.

### BRIEF SUMMARY

Disclosed herein are system, apparatus, device, method and/or computer program product embodiments, and/or combinations and sub-combinations thereof for making a payment from a customer to a merchant using a peer-to-peer (P2P) payment mechanism. Embodiments herein provide security protection to the merchant by not revealing a P2P payment identification (e.g., a token or other item of information) of the merchant to the customer. The terms “customer” and “merchant” are used here broadly, where the customer may be any payer and the merchant may be any payee.

A method for making a payment includes receiving a P2P payment identification of a customer by an application programming interface (API) operated by a processor. The P2P payment identification of the customer identifies the customer in a P2P payment system. Similarly, a P2P payment identification of a merchant identifies the merchant in the P2P payment system. The method further includes providing a customer-facing merchant identification to identify the merchant to the customer, where the customer-facing merchant identification is different from the P2P payment identification of the merchant. Moreover, the method includes generating a payment request to initiate a payment over the P2P payment system from the customer to the merchant for a commercial transaction between the merchant and the customer, where the payment request includes the customer-facing merchant identification. Afterwards, the method includes sending the payment request to a customer device associated with the P2P payment identification of the customer, and receiving, from the customer device, a response to the payment request. When the response indicates an approval of the payment request by the customer, the method includes sending, to the P2P payment system, an instruction to fulfill the payment to the merchant from the customer. In an embodiment, the instruction includes the approval of the payment request, the P2P payment identification of the merchant, and the P2P payment identification of the customer.

The P2P payment identification of the customer is associated with a monetary account, e.g., a bank account, of the customer. Similarly, the P2P payment identification of the merchant is associated with a monetary account, e.g., a bank account, of the merchant. In some embodiments, the P2P payment system, upon receiving the instruction to fulfill the payment, communicates with an Automated Clearing House (ACH) payment system to transfer funds from the bank account of the customer to the bank account of the merchant.

In some embodiments, the P2P payment identification of the customer may include an email address or a telephone number of the customer, and may be received from a QR code. On the other hand, the customer-facing merchant identification may include a name of the merchant or a logo of the merchant to identify the merchant to the customer.

The method may be performed by a system integrated with a merchant server and the P2P payment system. For example, the P2P payment identification of the customer may be received in response to a request made by the merchant server during a shopping flow by the customer. For example, the P2P payment identification of the customer may be submitted at a checkout time of an online shopping activity by the customer. The method may further include tracking a status of the payment request. In addition, the method may include determining, based on the status of the payment request, a status of the commercial transaction between the merchant and the customer.

Descriptions provided in the summary section represent only examples of the embodiments. Other embodiments in the disclosure may provide varying scopes different from the description in the summary. In some embodiments, systems and computer program products of the disclosed embodiments may include a computer-readable device storing computer instructions for any of the methods disclosed herein or one or more processors configured to read instructions from the computer readable device to perform any of the methods disclosed herein.

### BRIEF DESCRIPTION OF THE DRAWINGS

The accompanying drawings are incorporated herein and form a part of the specification.

FIG. 1 is a block diagram of a system for making a payment over a peer-to-peer (P2P) payment system from a customer to a merchant, according to an embodiment of the disclosure;

FIG. 2 is a block diagram of a system for making a payment over a P2P payment system from a customer to a merchant, according to an embodiment of the disclosure;

FIG. 3 is a flowchart illustrating a process for making a payment over a P2P payment system from a customer to a merchant, according to an embodiment of the disclosure;

FIG. 4 is a flowchart illustrating a process for making a payment over a P2P payment system from a customer to a merchant, according to an embodiment of the disclosure; and

FIG. 5 is a block diagram of an example environment in which systems and/or methods described herein may be implemented, according to an embodiment of the disclosure;

FIG. 6 is a computing environment suitable for implementing systems and methods of making a payment over a P2P payment system from a customer to a merchant, according to embodiments of the disclosure.

In the drawings, like reference numbers generally indicate identical or similar elements. Additionally, generally, the left-most digit(s) of a reference number identifies the drawing in which the reference number first appears.

### DETAILED DESCRIPTION

The disclosed embodiments enable making a payment from a customer to a merchant using a peer-to-peer (P2P) payment identification of the customer over a P2P payment system. Embodiments herein may provide security protection to the merchant by not revealing all the details of a P2P payment identification of the merchant to the customer.

A payment is a transfer of value from one party, a sender or a payer, to another party, a receiver or a payee. Depending on the identity of the payer or payee, a payment may be classified into different categories, such as a person-to-person payment, a person to business (P2B) payment, a business to business (B2B) payment, a business to customer (B2C) payment, a bank to bank payment, or others. In the current disclosure, the term “business” may be used interchangeably with a “merchant.”

A bank to bank payment may use the automated clearing house (ACH) system to provide a way to move money between accounts at different banks electronically. Traditionally, a personal payment may be made from one party to another party using, e.g., cash, checks, charge cards, credit cards, debit cards, or prepaid cards, which may involve person-to-person contact. Some electronic transfers for payment, e.g., wire transfers, have to be initiated by a bank and sent to another bank. The Internet revolution has brought many electronic person-to-person payment systems, e.g., Zelle®, PayPal®, Venmo®, and others. Not all person-to-person payment systems are the same. For example, bank-centric P2P payment systems (such as Zelle®, Dwolla®, ClearXchange®, and Popmoney®) do not have a standalone monetary account for a customer as part of the Zelle® architecture. Instead, bank-centric payment systems are linked to an existing bank account of the customer. The bank-centric payment system merely facilities fund transfers between different bank accounts. On the other hand, wallet-style payment systems (such as PayPal®, Square Cash®, and Venmo®) store a wallet or an account for a customer within the payment system, so that fund transfers can happen between the payment systems' own accounts.

The current person-to-person bank-centric payment systems typically are used for making person-to-person payments based on a personal token, e.g., a phone number or an email address, which is the same personal token linked to the person's bank account. Some may have extended a person-to-person payment system to pay a merchant or businesses. Once a merchant registers an account in a person-to-person payment system using a token, the person-to-person payment system may be used to make a payment from a person to that merchant. However, in the current bank-centric systems, such a merchant account is indistinguishable from a standard individual account, except that it happens to be owned by a merchant instead of an individual. In order for a customer to make a payment to the merchant, the customer needs to know the token of the merchant, which may pose a security risk to the merchant. Additionally, even if the customer does know the merchant token, if the customer initiated a person-to-person payment to the merchant, the merchant would have no way of knowing what transaction the payment should be linked to, as the person-to-person payment occurs fully outside the shopping payment process flow typically performed between a customer and merchant. Thus it may be difficult to completely close transactions where current bank-centric P2P systems are used to transfer funds from the customer to the merchant.

The customer may pay the merchant in other more secure ways but with inconvenience. As an example, a customer may use a home computer to shop on a shopping website. The checkout page of the shopping website may request that the customer provide a credit card to make payment for an order. However, to transfer such funds to the merchant, the customer will have to maintain a separate credit card account, enter the credit card details into the website (thus risking the security of that credit card number), and transfer the actual monetary funds from the customer's bank account to the credit account later, causing inconvenience. Other options may include using a separate, standalone payment system such as the wallet-style P2P systems listed above to transfer funds from the wallet of the customer to the wallet of the shopping website merchant. But fund transfers using a wallet-style P2P system account typically require a separate login to the wallet-style P2P system, and require separate transfers between the bank account and the wallet-style P2P system account to gain access to the funds, which causes an extra delay and inconvenience to one or both parties.

Embodiments herein disclose a system that enables the customer to make the payment using a bank-centric payment system, such that the customer's personal token can be provided to the merchant on a shopping website in lieu of a credit card number and without having to log into a separate account. For example, the customer may provide a personal token (such as an email address or telephone number) to make the payment for the order at the shopping website. Once the customer provides the personal token, the bank-centric P2P system takes over and sends, through a separate application program interface (API), a request for payment that can be approved by the customer, but that has direct access into and out of the respective bank accounts. For example, the API may be a banking app associated with the bank holding the customer's bank account. As such, embodiments herein provide more secure protection to the merchant, and also provide a capability for the merchant to tie the incoming P2P payment to the customer's order online at the shopping website.

Accordingly, embodiments herein enable making a payment through a peer-to-peer (P2P) (also referred to as a person-to-person) payment system during a routine commercial transaction between the merchant and the customer. In the current disclosure, a P2P payment system may include any of the person-to-person payment system, a P2B payment system, a B2B payment system, a B2C payment system, as long as the methods and the system structures disclosed herein are followed.

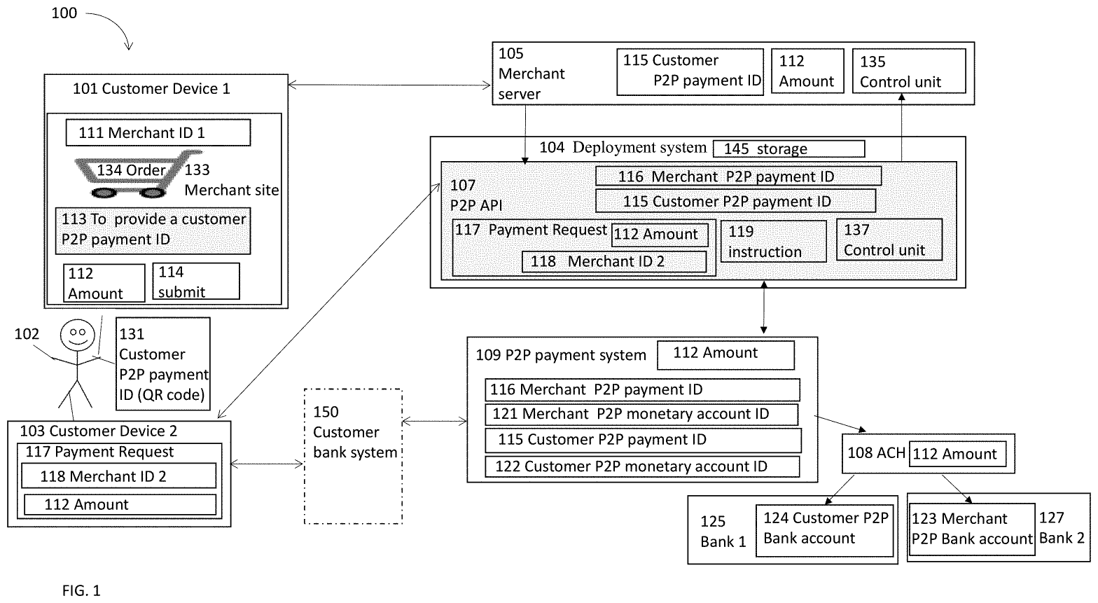

FIG. 1 is a block diagram of a system 100 for making a payment over a P2P payment system from a customer to a merchant, according to an embodiment of the disclosure. In the embodiment of FIG. 1, the system 100 includes a customer 102, a customer device 101, a customer device 103, a merchant server 105, a P2P API 107 operated on a deployment system 104, a P2P payment system 109, and an ACH 108. The customer 102 may have multiple customer devices, e.g., the customer device 101 and the customer device 103. In some embodiments, the deployment system 104 may be a third-party system in communication with the P2P payment system 109, the merchant server 105 associated with the merchant, and the customer device 101 and the customer device 103 associated with the customer. In some embodiments, the deployment system 104 may be associated with a bank system holding an account of one or both of the customer 102 or the merchant. For example, the P2P API 107 may be a banking app associated with a bank system 150 at which the customer has an account.

In embodiments, the customer 102 may be engaged in a commercial transaction between the merchant and the customer 102, e.g., online shopping at a merchant site 133. In detail, the customer 102 may be performing online shopping on the merchant site 133 displayed on the customer device 101, where the merchant site 133 may be provided by the merchant server 105 in communication with the customer device 101. Contents displayed on the merchant site 133 and requests made on the merchant site 133 may be provided by the merchant server 105. The merchant site 133 may display a customer-facing merchant identification 111 to identify the merchant to the customer 102. The customer 102 may have selected a group of items to be included in an order 134. At some moment during a shopping flow by the customer 102, the merchant server 105 through the merchant site 133 may request the customer 102 to provide a P2P payment identification of the customer as a way to make the payment for the order 134. For example, the merchant site 133 may provide the request as an option so that the customer 102 may select to pay by credit card or by a P2P payment system. If the customer 102 selects to make the payment by a bank-centric P2P payment system, such that the payment will come directly out of the customer's bank account as a bank-to-bank transfer, the merchant site 133 may provide a space 113 so that the customer 102 may provide the P2P payment identification of the customer, e.g., a telephone number or an email address of the customer 102. For example, if the P2P payment system is Zelle®, the P2P payment identification of the customer may be an identification associated with the customer's Zelle® or bank credentials, such that the token is associated directly with the customer's banking account. In addition, the merchant site 133 may further provide an amount 112 to be paid to the merchant for the order 134, and a submit button 114 to complete the order 134 at a checkout time. As a result, at the checkout time of the online shopping activity by the customer 102, the order 134 may be submitted to the merchant server 105 together with the P2P payment identification of the customer 115 provided at the space 113. In some other embodiments, the P2P payment identification of the customer 115 may be submitted by the customer using a QR code 131.

As an example, the customer 102 may use a home computer to shop on the Amazon® shopping website. The checkout page of the Amazon® shopping website may request that the customer provide the customer's Zelle® or bank token as a P2P payment identification of the customer to make payment for the order 134. The customer 102 then provides the token as the P2P payment identification of the customer 115.

In embodiments, the merchant server 105 receives the P2P payment identification of the customer 115 together with the amount 112 to be paid to the merchant from the customer 102 associated with the commercial transaction, e.g., the order 134. The merchant server 105 sends the P2P payment identification of the customer 115 together with the amount 112 to the P2P API 107 for further processing. In some embodiments, the merchant server 105 may also send to the P2P API 107 information about the merchant, e.g., a customer-facing merchant identification 118 or a P2P payment identification of the merchant 116. The information about the customer-facing merchant identification 118 or the P2P payment identification of the merchant 116 may be sent by QR code. In addition, the merchant server 105 may include a control unit 135 to track a status of the payment and the status of the commercial transaction between the merchant and the customer. For example, the control unit 135 may stop the shipment of the order 134 when the payment is rejected by the customer 102, save the order 134 without shipment when the payment is declined by the P2P payment system 109, or fail to complete the order 134 when the payment request times out (e.g., if the customer does not complete the payment within a given time period).

In embodiments, the P2P API 107, which is operated on the deployment system 104, receives from the merchant server 105 the P2P payment identification of the customer 115, and the amount 112 to be paid from the customer to the merchant associated with the order 134. The P2P API 107 stores the P2P payment identification of the customer 115 in a storage device 145. In addition, the P2P API 107 also stores in the storage device 145 the P2P payment identification of the merchant 116 that identifies the merchant in the P2P payment system 109. The P2P API 107 further determines the customer-facing merchant identification 118 to identify the merchant to the customer 102. In some embodiments, the customer-facing merchant identification 118 is different from the P2P payment identification of the merchant 116. In some embodiments, the customer-facing merchant identification 118 may be received from the merchant server 105. In some other embodiments, the customer-facing merchant identification 118 may be retrieved from a database stored in the storage device 145. For example, the P2P API 107 may search the database in the storage device 145 using an indicator of the merchant server, e.g., an IP address of the merchant server, to find the corresponding customer-facing merchant identification 118 stored in the storage device 145. In addition, in some embodiments, the customer-facing merchant identification 118 is different from the customer-facing merchant identification 111 displayed on the merchant site 133 to the customer 102. The customer-facing merchant identification 118 may include a name of the merchant or a logo of the merchant to identify the merchant to the customer. By having the customer-facing merchant identification 118 different from the P2P payment identification of the merchant 116, the P2P API 107 protects the sensitive information, which is the P2P payment identification of the merchant 116. By doing so, the P2P API 107 also represents an improvement of the technology compared to the current person-to-person payment system, where the P2P payment identification of the merchant 116 may be revealed to the customer 102.

In embodiments, the P2P API 107 generates a payment request 117 to initiate a payment over the P2P payment system 109 from the customer 102 to the merchant for a commercial transaction between the merchant and the customer, e.g., the order 134. In some embodiments, the payment request 117 includes the customer-facing merchant identification 118, and the amount 112 to be paid from the customer to the merchant. In addition, other forms of payment requests are possible for other embodiments. For example, in an embodiment, the payment request 117 may not include the amount 112, but instead includes a link to a website. After receiving the payment request 117, the customer 112 may go to the link to review the amount 112 to be paid and the details of the order 134 to ensure the correctness of the amount 112 to be paid to the merchant.

To continue the example for the customer 102 shopping on the Amazon® shopping website, the customer's Zelle® token is transferred from the Amazon® shopping website displayed on the customer's home computer to a merchant server of Amazon®, and further transferred to the P2P API 107 that is integrated with the Amazon® shopping website and the bank-centric P2P payment system 109, e.g., Zelle®. The P2P API 107 generates the payment request 117 indicating that a payment is to be made to Amazon®, without revealing the Zelle® token or other credentials of Amazon®. In addition, the P2P API 107 keeps a record of the link between Amazon® and the Zelle® token of Amazon®. In this way, the Zelle® token or other banking credential of Amazon® is protected to provide more security to the merchant Amazon®.

In embodiments, the P2P API 107 sends the payment request 117 to the customer device 103 associated with the P2P payment identification of the customer 115. As shown in FIG. 1, the customer device 103 may be a device different from the customer device 101. For example, the customer device 101 may be a home computer where the customer 102 places the order 134, while the customer device 103 may be a cellular phone where the payment request 117 is sent as a text message received by the customer device 103. On the other hand, when the P2P payment identification of the customer 115 is an email address, the payment request 117 may be sent as an email and received by the customer device 103. In some embodiments, the customer device 103 may be a same device as the customer device 101.

To continue the example for the customer 102 shopping on the Amazon® shopping website, the P2P API 107 sends to the customer's phone a payment request to pay using Zelle®. The customer's phone may be a device different from a home computer where the online shopping activity is happening. In an embodiment, the payment request to pay using Zelle® is sent by the P2P API, which is associated with and has direct access to the customer's monetary account, not sent by Zelle® itself. Hence, the payment request may be sent to the customer device 103 without a dedicated Zelle® app or a bank app providing access to Zelle® installed on the customer device 103. Some existing person-to-person payment apps are already cashless, contactless, card free, but they need one to access and login to a dedicated payment app or a bank app first. For example, using existing Zelle®, the merchant has to log in to Zelle® or a bank app that provides access to Zelle®, provide the customer's Zelle® token, and make the request through Zelle®, which includes more operations and more delays.

The customer device 103 receives the payment request 117 sent by the P2P API 107. The customer 102 in possession of the customer device 103 may review the payment request 117 and determine an appropriate action to take with respect to the payment request 117. For example, the customer 112 may approve, reject, or cancel the payment request 117, or request more information from the P2P API 107 about the payment request 117. The customer device 103 sends a response to the P2P API 107 to indicate the customer's decision on the payment request 117. If the payment request 117 is received by an email, the customer 102 may send the response to the P2P API 107 by a replying email. On the other hand, if the payment request 117 is received by a text message, the customer 102 may send the response to the P2P API 107 by a text message. The email or the text message containing the payment request 117 may indicate that the customer 102 may simply reply “yes” to approve or “no” to cancel the payment request 117. In some other embodiments, there may be an app running on the customer device 103 with a graphic interface so that the received payment request 117, either by email or by text message, can be displayed in a graphic manner. The customer 102 may simply send the response by pressing a “yes” or “approve” button on the graphics interface to approve the payment request 117, or pressing a “no” or “cancel” button to cancel the payment request 117.

In embodiments, the P2P API 107 receives, from the customer device 103, a response to the payment request 117. When the response indicates an approval of the payment request by the customer, the P2P API 107 sends, to the P2P payment system 109, an instruction 119 to fulfill the payment to the merchant from the customer 102. In this case, the instruction 119 includes the approval of the payment request, the P2P payment identification of the merchant 116, and the P2P payment identification of the customer 115. For example, the instruction 119 may include an instruction to transfer funds from a monetary account of the customer 102 to a monetary account of the merchant. On the other hand, when the response indicates a rejection or cancellation of the payment request by the customer 102, the P2P API 107 sends to the merchant server 105 the instruction 119 with a content to stop fulfilling the commercial transaction between the merchant and the customer 102.

In embodiments, the P2P API 107 further includes a control unit 137 to perform the above-described functions or operations, e.g., determining the customer-facing merchant identification 118, generating the payment request 117, and more. In addition, the control unit 137 may further track a status of the payment request 117, and determine, based on the status of the payment request 117, a status of the commercial transaction between the merchant and the customer 102. For example, the status of the payment request 117 may be waiting for a response from the customer, and a status of the commercial transaction may be determined to be withholding to wait for the response from the customer. The control unit 137 of the P2P API 107 further communicates with the control unit 135 of the merchant server 105 to coordinate the operations performed by the control unit 135 based on the status of the payment request 117.

In embodiments, the P2P payment system 109 may receive the instruction 119 from the P2P API 107, where the instruction 119 includes the approval of the payment request, the P2P payment identification of the merchant 116, and the P2P payment identification of the customer 115. In addition, the P2P payment system 109 includes a monetary account identification of the customer 122 associated with the P2P payment identification of the customer 115, and a monetary account identification of the merchant 121 associated with P2P payment identification of the merchant 116.

The operation flow outlined above is merely an example. There may be other communication sequences to achieve the same functions to send the payment request 117 to the customer device 103 associated with the P2P payment identification of the customer 115, and further receive the response to the payment request. For example, the P2P API 107 may send the payment request 117 to the P2P payment system 109. The P2P payment system 109 may verify the P2P payment identification of the customer 115 to be a valid P2P payment identification before sending the payment request 117 to the customer device 103. The P2P payment system 109 may send the payment request 117 directly to the customer device 103, or indirectly through the P2P API 107 again. In some other embodiments, after receiving the payment request 117, the P2P payment system 109 may transmit the payment request 117 to the customer bank system 150 to verify the customer has enough fund in the customer bank system 150. Furthermore, the customer bank system 150 may then transmit the payment request 117 to the customer device 103. Similarly, the response to the payment request 117 by the customer 102 may go through various paths to reach the P2P API 107 or the P2P payment system 109. Eventually, the P2P payment system 109 may communicate with the ACH payment system 108 to fulfill the payment to the merchant.

In some embodiments, the monetary account identification of the merchant 121 may be an identification of a bank account of the merchant 123 located in a bank 127, and the monetary account identification of the customer 122 may be an identification of a bank account of the customer 124 located in a bank 125. As such, the monetary account identification of the merchant 121 or the monetary account identification of the customer 122 does not store, save, or keep track of fund transactions. Instead, they are just pointers to bank accounts in various banks. Accordingly, the bank-centric P2P payment system 109, e.g., Dwolla®, Zelle®, PopMoney®, clearXchange®, may communicate with the ACH payment system 108 to transfer the amount 112 of funds from the bank account of the customer 124 to the bank account of the merchant 123. The bank 125 and the bank 127 may be the same bank or different banks depending on the customer and the merchant situations. When the payment is made by transferring the amount 112 of funds from the bank account of the customer 124 to the bank account of the merchant 123, there may be no fee charged by the P2P payment system 109, the bank 125, or the bank 127. In some embodiments, there may be a fee charged, e.g., $0.10.

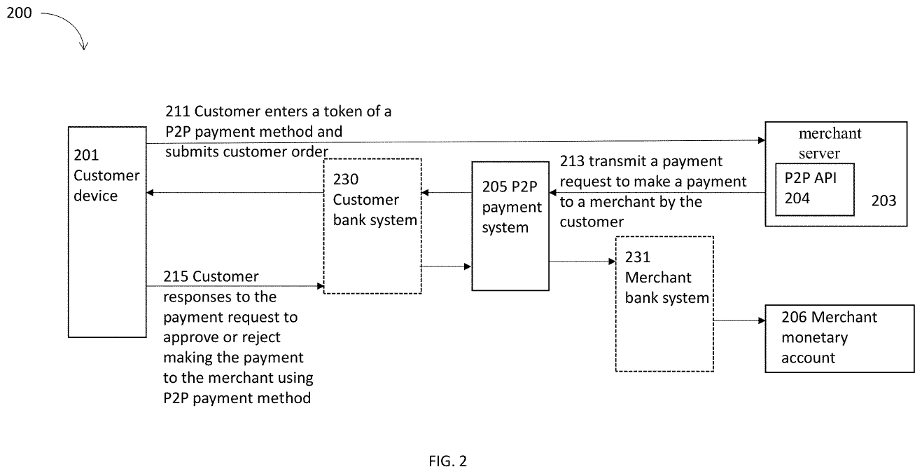

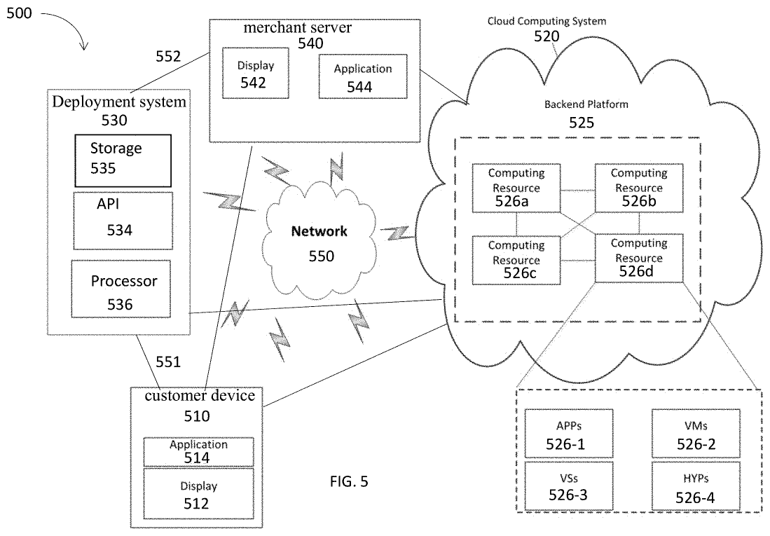

FIG. 1 merely illustrates one implementation of a system for making a payment over a P2P payment system by a customer to a merchant. There may be other systems to implement the same functions, as shown in FIG. 2 or FIG. 5.

FIG. 2 is a block diagram of a system 200 for making a payment over a P2P payment system by a customer to a merchant, according to an embodiment of the disclosure. As shown in FIG. 2, the system 200 includes a customer device 201, a merchant server 203, and a P2P payment system 205. A P2P API 204 operates on the merchant server 203 to interface with the P2P payment system 205. The P2P payment system 205 further provides access to a monetary account of the merchant 206 associated with the P2P payment system 205, in addition to the monetary account of the customer. FIG. 2 shows a similar concept as FIG. 1, but in a different implementation. The customer device 201 may represent both of the customer device 101 and the customer device 103, as shown in FIG. 1. In addition, the merchant server 203 may serve as a combination of the merchant server 105 and the deployment system 104 shown in FIG. 1 so that the P2P API 204 operates on the merchant server 203. Furthermore, the P2P payment system 205 may be an example of the P2P payment system 109 as shown in FIG. 1.

In embodiments, the system 200, e.g., the customer device 201, the merchant server 203, and the P2P payment system 205 may perform various functions and operations related to making a payment over the P2P payment system 205. The payment may be from the customer using the customer device 201 to a merchant through the merchant server 203. In addition, the payment may be for a commercial transaction between the merchant and the customer.

In embodiments, at 211, on the customer device 201, the customer may enter a P2P payment identification of a customer, e.g., a token of a P2P payment method, during a commercial transaction between the merchant and the customer. The P2P payment identification of the customer identifies the customer in the P2P payment system 205. For example, the P2P payment identification of the customer includes an email address or a telephone number of the customer. The token may be submitted together with a customer order to the merchant server 203, and further transmitted to the P2P API 204. The P2P API 204 generates a payment request to initiate a payment over the P2P payment system 205 from the customer to the merchant for the commercial transaction. The payment request includes a customer-facing merchant identification. The customer-facing merchant identification is different from a P2P payment identification of the merchant. The customer-facing merchant identification identifies the merchant to the customer, while the P2P payment identification of the merchant identifies the merchant in the P2P payment system. For example, the customer-facing merchant identification may include a name of the merchant or a logo of the merchant to identify the merchant to the customer, while the P2P payment identification of the merchant may include a telephone number or an email address of the merchant used to access the merchant's monetary account, which is only provided to the P2P payment system and not the customer.

In embodiments, at 213, the P2P API 204 transmits the payment request to the customer device 201 through a communication channel associated with the P2P payment identification of the customer. For example, when the P2P payment identification of the customer is an email address, the payment request may be sent to the customer device 201 in an email. On the other hand, when the P2P payment identification of the customer is a telephone number, the payment request may be sent to the customer device 201 in a text message through a cellular network. Furthermore, the payment request may be transmitted through the P2P payment system 205, which may be further transmitted through a customer bank system 230 before reaching the customer device 201. In some embodiments, the P2P payment system 205 may verify that the P2P payment identification of the customer is a valid identification within the P2P payment system 205. In addition, in some embodiments, the customer bank system 230 may be the same as the P2P API 204, such that an additional step is not needed.

In embodiments, at 215, the P2P payment system 205 receives, from the customer device 201, the customer's response to the payment request. When the received response from the customer device 201 indicates an approval of the payment request, the P2P payment system 205 fulfills the payment to the merchant from the customer. There may be intermediate operations performed so that the P2P payment system 205 may fulfill the payment to the merchant from the customer. For example, the response from the customer device 201 may be received by the P2P API 204 instead of being received directly by the P2P payment system 205. In some other embodiments, the response from the customer device 201 may be received by the customer bank system 230 before passing to the P2P payment system 205. When the P2P API 204 receives the response from the customer device 201, the P2P API 204 may send, to the P2P payment system 205, an instruction to fulfill the payment to the merchant from the customer. In detail, the instruction may include the approval of the payment request, a P2P payment identification of the merchant, and the P2P payment identification of the customer. Alternatively, when the response from the customer device 201 is received by the P2P payment system 205, the P2P payment system 205 may fulfill the payment to the merchant from the customer.

In some embodiments, the P2P payment identification of the customer is associated with a bank account of the customer, and the P2P payment identification of the merchant is associated with a bank account of the merchant. In some embodiments, the P2P payment system 205 communicates with an Automated Clearing House (ACH) payment system to transfer funds from the bank account of the customer to the bank account of the merchant 206 to fulfill the payment to the merchant from the customer. Alternatively, the P2P payment system 205 may communicate with a merchant bank system 231 directly to transfer funds from the bank account of the customer to the bank account of the merchant 206.

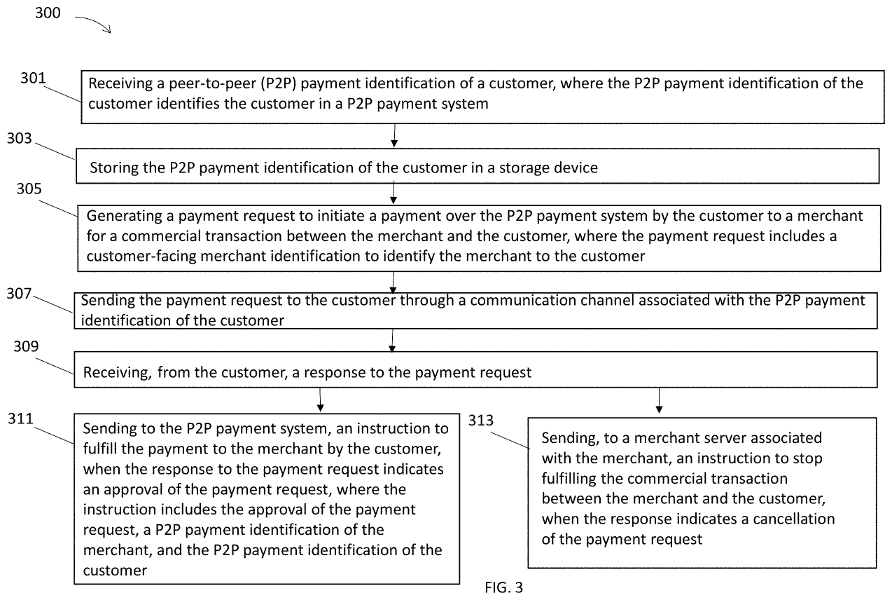

FIG. 3 is a flowchart illustrating a process 300 for making a payment over a P2P payment system by a customer to a merchant, according to an embodiment of the disclosure. In some embodiments, the process 300 may be performed by the P2P API 107 as shown in FIG. 1.

At 301, the process 300 may include receiving a P2P payment identification of a customer, where the P2P payment identification of the customer identifies the customer in a P2P payment system. For example, the P2P API 107 receives the P2P payment identification of the customer 115 from the merchant server 105.

At 303, the process 300 may include storing the P2P payment identification of the customer in a storage device. For example, the P2P API 107 stores the P2P payment identification of the customer 115 in the storage device 145.

At 305, the process 300 may include generating a payment request to initiate a payment over the P2P payment system from the customer to a merchant for a commercial transaction between the merchant and the customer. The payment request includes a customer-facing merchant identification to identify the merchant to the customer. For example, the P2P API 107 generates the payment request 117 to initiate a payment over the P2P payment system 109 for the order 134. The payment request 117 includes the customer-facing merchant identification 118 to identify the merchant to the customer.

At 307, the process 300 may include sending the payment request to the customer through a communication channel associated with the P2P payment identification of the customer. In an embodiment, the P2P API 107 sends the payment request 117 to the customer 102 by way of the customer device 103 through a communication channel associated with the P2P payment identification of the customer 115. For example, when the P2P payment identification of the customer 115 is a telephone number of the customer 102, the payment request 117 to the customer 102 is sent by text message through a cellular communication channel.

At 309, the process 300 may include receiving, from the customer, a response to the payment request. For example, the P2P API 107 receives, from the customer 102, a response to the payment request 117. The response may be generated, for example, based on a selection by the customer from one or more options for response displayed on the customer's device by the P2P API.

At 311, the process 300 may include sending, to the P2P payment system, an instruction to fulfill the payment to the merchant from the customer, when the response to the payment request indicates an approval of the payment request. The instruction includes the approval of the payment request, a P2P payment identification of the merchant, and the P2P payment identification of the customer. For example, when the response to the payment request 117 indicates an approval of the payment request 117, the P2P API 107 sends to the P2P payment system 109 the instruction 119 to fulfill the payment to the merchant from the customer 102.

At 313, the process 300 may include sending, to a merchant server associated with the merchant, an instruction to stop fulfilling the commercial transaction between the merchant and the customer, when the response indicates a cancellation of the payment request. For example, when the response indicates a cancellation of the payment request 117, the P2P API 107 sends, to the merchant server 105, the instruction 119 to stop fulfilling the commercial transaction between the merchant and the customer.

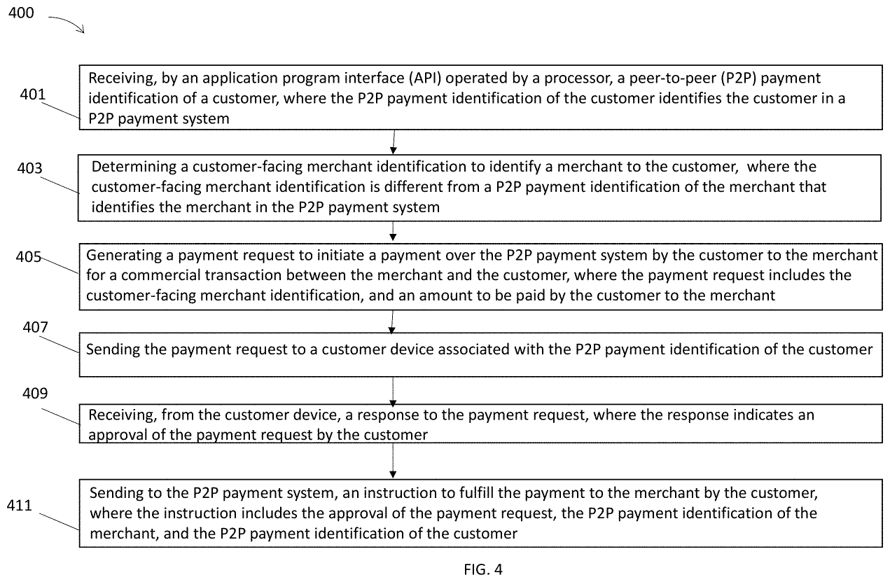

FIG. 4 is a flowchart illustrating a process 400 for making a payment over a P2P payment system from a customer to a merchant, according to an embodiment of the disclosure. In some embodiments, the process 400 may be performed by the P2P API 107 as shown in FIG. 1.

At 401, the process 400 may include receiving, by an API operated by a processor, a P2P payment identification of a customer, where the P2P payment identification of the customer identifies the customer in a P2P payment system. For example, the P2P API 107 receives the P2P payment identification of the customer 115 from the merchant server 105.

At 403, the process 400 may include determining a customer-facing merchant identification to identify a merchant to the customer, where the customer-facing merchant identification is different from a P2P payment identification of the merchant that identifies the merchant in the P2P payment system. For example, the P2P API 107 may determine the customer-facing merchant identification 118 to identify a merchant to the customer 102, where the customer-facing merchant identification 118 is different from the P2P payment identification of the merchant 116.

At 405, the process 400 may include generating a payment request to initiate a payment over the P2P payment system from the customer to a merchant for a commercial transaction between the merchant and the customer. The payment request includes a customer-facing merchant identification to identify the merchant to the customer, and an amount to be paid from the customer to the merchant. For example, the P2P API 107 generates the payment request 117 to initiate a payment over the P2P payment system 109 for the order 134. The payment request 117 includes the customer-facing merchant identification 118 to identify the merchant to the customer, and the amount 112 to be paid form the customer 102.

At 407, the process 400 may include sending the payment request to a customer device associated with the P2P payment identification of the customer. For example, the P2P API 107 sends the payment request 117 to the customer device 103 associated with the P2P payment identification of the customer 115. When the P2P payment identification of the customer 115 is a telephone number of the customer 102, the customer device 103 may be a cellular phone.

At 409, the process 400 may include receiving, from the customer device, a response to the payment request, where the response indicates an approval of the payment request by the customer. For example, the P2P API 107 receives, from the customer device 103, a response to the payment request 117. The response indicates an approval of the payment request 117 by the customer 102.

At 411, the process 400 may include sending to the P2P payment system, an instruction to fulfill the payment to the merchant from the customer, where the instruction includes the approval of the payment request, the P2P payment identification of the merchant, and the P2P payment identification of the customer. For example, when the response to the payment request 117 indicates an approval of the payment request 117, the P2P API 107 sends to the P2P payment system 109 the instruction 119 to fulfill the payment to the merchant from the customer 102.

FIG. 5 is a block diagram of an example environment 500 in which systems and/or methods described herein may be implemented. As shown in FIG. 5, environment 500 may include a customer device 510, a deployment system 530, a merchant server 540, a cloud computing system 520, and a network 550. Devices of the environment 500 may interconnect via wired connections, wireless connections, or a combination of wired and wireless connections to form the network 550 including various communication channels, e.g., a communication channel 551 between the deployment system 530 and the customer device 510, a communication channel 552 between the deployment system 530 and merchant server 540, etc. The environment 500 may implement various payment systems, e.g., the payment system 100 shown in FIG. 1. For example, the customer device 510, the merchant server 540, the API 534, and the deployment system 530 may be examples of the customer device 101, the customer device 103, the merchant server 105, the P2P API 107, and the deployment system 104, respectively, as shown in FIG. 5. Furthermore, the P2P payment system 109 and the ACH 108 may be an example of the Application 526-1 as a part of the cloud computing resources 526a-d of the cloud computing system 520, as shown in FIG. 5.

In some embodiments, the customer device 510 may be any device used by a customer to perform various computing or communication tasks, e.g., receiving emails or texts, shopping online, and more. For example, the customer device 510 may be a mobile phone (e.g., a smart phone, a radiotelephone, etc.), a laptop computer, a tablet computer, a handheld computer, a gaming device, a wearable communication device (e.g., a smart wristwatch, a pair of smart eyeglasses, etc.), a desktop computer, a server, an embedded device, or a similar type of device. The customer device 510 may include a display 512, and one or more mobile applications 514. For example, the one or more mobile applications 514 may include an online shopping app, an app to receive texts or emails, or a mobile application associated with a P2P payment system. In some embodiments, the customer device 510 may receive a text or email including a payment request through the communication channel 551 from the deployment system 530. When the payment request is received by a text message, the communication channel 551 may include a cellular communication channel as a portion of the communication channel 551. On the other hand, when the payment request is received by an email, the communication channel 551 may traverse a part of the Internet.

In some embodiments, the merchant server 540 may include a server device (e.g., a host server, a web server, an application server, etc.), a data center device, or a similar device, capable of communicating with the deployment system 530 by the communication channel 552, the customer device 510, and the cloud computing system 520. The merchant server 540 may include a display 542, and may host one or more application 544, e.g., a shopping website, to perform various functions to facilitate commercial transactions between the merchant server 540 and the customer device 510, and related payments to the merchant by a customer.

In some embodiments, the deployment system 530 may include a storage device 535, a processor 536 coupled to the storage device 535, and more. In addition, an API 534, e.g., a P2P payment API, may be operated by the processor 536. In some embodiments, the processor 536 may represent a pool of multiple computing cores. The deployment system 530 may interact with the merchant server 540, the customer device 510, and the cloud computing system 520, to perform various functions further described with respect to FIG. 1-FIG. 4. The deployment system 530 is shown as merely an example. In some embodiments, the functions of the deployment system 530 may be implemented by the merchant server 540, or other components of the environment 500.

In some embodiments, one or more portions of the network 550 may be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

In some embodiments, the cloud computing system 520 includes an environment that delivers computing as a service, whereby shared resources, services, etc. The cloud computing system 520 may provide computation, software, data access, storage, and/or other services that do not require end-user knowledge of a physical location and configuration of a system and/or a device that delivers the services. The cloud computing system 520 may include computer resources 526a-d, which may form a backend platform 525. It may be appreciated that the backend platform 525 may not be cloud-based, or may be partially cloud-based.

Each computing resource 526a-d includes one or more personal computers, workstations, computers, server devices, or other types of computation and/or communication devices. The cloud resources may include computing instances executing in the cloud computing resources 526a-d. The cloud computing resources 526a-d may communicate with other cloud computing resources 526a-d via wired connections, wireless connections, or a combination of wired or wireless connections.

Computing resources 526a-d may include a group of cloud resources, such as one or more applications (“APPs”) 526-1, one or more virtual machines (“VMs”) 526-2, virtualized storage (“VS”) 526-3, and one or more hypervisors (“HYPs”) 526-4. For example, the P2P payment system 109 and the ACH 108 may be an example of the Application 526-1 as a part of the cloud computing resources 526a-d.

Application 526-1 may include one or more software applications that may be provided to or accessed by other components, e.g., the merchant server 540, the deployment system 530, or the customer device 510. In an embodiment, the application 526-1 may execute locally on the merchant server 540, the deployment system 530, or the customer device 510. Alternatively, the application 526-1 may eliminate a need to install and execute software applications on the merchant server 540, the deployment system 530, or the customer device 510. The application 526-1 may include software associated with the backend platform 525 and/or any other software configured to be provided across the cloud computing system 520. The application 526-1 may send/receive information from one or more other applications 526-1, via the virtual machine 526-2.

The virtual machine 526-2 may include a software implementation of a machine (e.g., a computer) that executes programs like a physical machine. The virtual machine 526-2 may be either a system virtual machine or a process virtual machine, depending upon the use and degree of correspondence to any real machine by the virtual machine 526-2. A system virtual machine may provide a complete system platform that supports execution of a complete operating system (OS). A process virtual machine may execute a single program and may support a single process. The virtual machine 526-2 may execute on behalf of a user (e.g., the merchant server 540, the deployment system 530, or the customer device 510) and/or on behalf of one or more other backend platforms 525, and may manage infrastructure of the cloud computing system 520, such as data management, synchronization, or long duration data transfers.

Virtualized storage 526-3 may include one or more storage systems and/or one or more devices that use virtualization techniques within the storage systems or devices of computing resources 526a-d. With respect to a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how administrators manage storage for end users. File virtualization may eliminate dependencies between data accessed at a file level and location where files are physically store. This may enable optimization of storage use, server consolidation, and/or performance of non-disruptive file migrations.

Hypervisor 526-4 may provide hardware virtualization techniques that allow multiple operations systems (e.g., “guest operating systems”) to execute concurrently on a host computer, such as computing resources 526a-d. Hypervisor 526-4 may present a virtual operating platform to the guest operating systems, and may manage the execution of the guest operating systems multiple instances of a variety of operating systems and may share virtualized hardware resource.

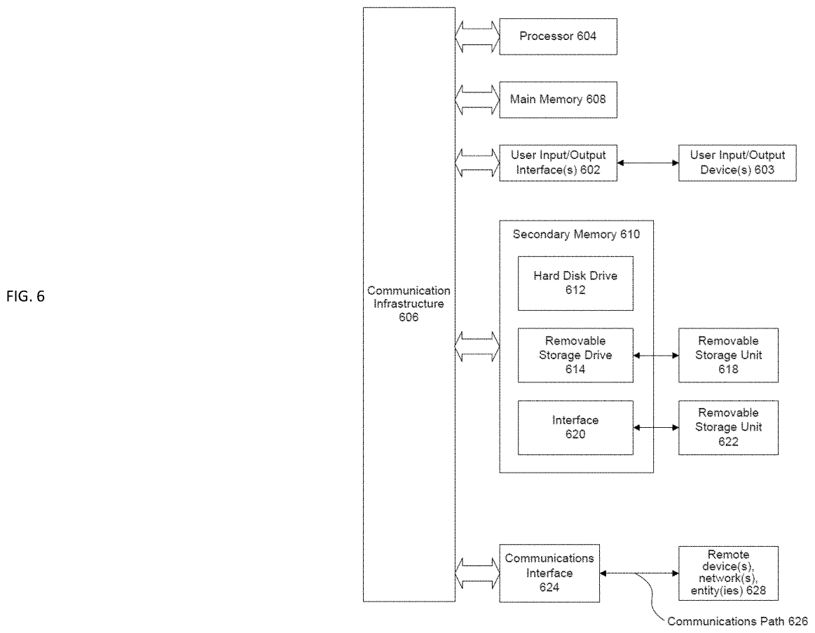

FIG. 6 depicts an example computer system 600 useful for implementing various embodiments. The computer system 600 may be an example of the customer device 510, the deployment system 530, the merchant server 540, the cloud computing system 520, as shown in FIG. 5, or the customer device 201, the merchant server 203, and the P2P payment system 205, as shown in FIG. 2, or the customer device 101, the customer device 103, the merchant server 105, the deployment system 104, the P2P payment system 109, and the ACH 108 as shown in FIG. 1.

Various embodiments may be implemented, for example, using one or more well-known computer systems, such as computer system 600 shown in FIG. 6. One or more computer systems 600 may be used, for example, to implement any of the embodiments discussed herein, as well as combinations and sub-combinations thereof.

Computer system 600 may include one or more processors (also called central processing units, or CPUs), such as a processor 604. Processor 604 may be connected to a communication infrastructure or bus 606.

Computer system 600 may also include user input/output device(s) 603, such as monitors, keyboards, pointing devices, etc., which may communicate with communication infrastructure or bus 606 through user input/output interface(s) 602.

One or more of processors 604 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 may also include a main or primary memory 608, such as random access memory (RAM). Main memory 608 may include one or more levels of cache. Main memory 608 may have stored therein control logic (i.e., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 may include a computer usable or readable storage device having stored thereon computer software (control logic) and/or data. Removable storage unit 618 may be a floppy disk, magnetic tape, compact disk, DVD, optical storage disk, and/ any other computer data storage device. Removable storage drive 614 may read from and/or write to removable storage unit 618.

Secondary memory 610 may include other means, devices, components, instrumentalities or other approaches for allowing computer programs and/or other instructions and/or data to be accessed by computer system 600. Such means, devices, components, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 may enable computer system 600 to communicate and interact with any combination of external devices, external networks, external entities, etc. (individually and collectively referenced by reference number 628). For example, communication interface 624 may allow computer system 600 to communicate with external or remote devices 628 over communications path 626, which may be wired and/or wireless (or a combination thereof), and which may include any combination of LANs, WANs, the Internet, etc. Control logic and/or data may be transmitted to and from computer system 600 via communication path 626.

Computer system 600 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 600 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 600 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described herein.

It is to be appreciated that the Detailed Description section, and not the Abstract section, is intended to be used to interpret the claims. The Abstract section may set forth one or more but not all exemplary embodiments of the present application as contemplated by the inventor(s), and thus, are not intended to limit the present application and the appended claims in any way.

The present application has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the application that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present application should not be limited by any of the above-described exemplary embodiments, but should be defined only in accordance with the following claims and their equivalents.

What is claimed is:

1. A system, comprising:
a storage device; and
a processor coupled to the storage device and configured to:
receive a peer-to-peer (P2P) payment identification of a customer, wherein the P2P payment identification of the customer identifies the customer in a P2P payment system;
generate a payment request to initiate a payment over the P2P payment system from the customer to a merchant for a commercial transaction between the merchant and the customer, wherein the payment request includes a customer-facing merchant identification to identify the merchant to the customer;
send the payment request to the customer through a communication channel associated with the P2P payment identification of the customer;
receive, from the customer, a response to the payment request, wherein the received response from the customer indicates an approval of the payment request; and
send, to the P2P payment system, an instruction to fulfill the payment to the merchant from the customer, wherein the instruction includes the approval of the payment request, a P2P payment identification of the merchant, and the P2P payment identification of the customer, wherein the P2P payment identification of the merchant identifies the merchant in the P2P payment system.

2. The system of claim 1, wherein the customer-facing merchant identification is different from the P2P payment identification of the merchant.

3. The system of claim 1, wherein the processor is further configured to:
track a status of the payment request; and
determine, based on the status of the payment request, a status of the commercial transaction between the merchant and the customer.

4. The system of claim 1, wherein the processor is further configured to receive an amount to be paid from the customer to the merchant associated with the commercial transaction, and wherein the payment request indicates the amount to be paid from the customer to the merchant associated with the commercial transaction.

5. The system of claim 1, wherein the P2P payment identification of the customer is received from a merchant server associated with the merchant and coupled to the system.

6. The system of claim 1, wherein the instruction to fulfill the payment comprises an instruction to transfer funds from a monetary account of the customer to a monetary account of the merchant.

7. The system of claim 1, wherein the system is located on a third-party system in communication with the P2P payment system, a merchant server associated with the merchant, and a customer device associated with the customer.

8. The system of claim 1, wherein the P2P payment identification of the customer includes an email address or a telephone number of the customer.

9. The system of claim 1, wherein the P2P payment identification of the customer is associated with a bank account of the customer, the P2P payment identification of the merchant is associated with a bank account of the merchant, and the P2P payment system communicates with an Automated Clearing House (ACH) payment system to transfer funds from the bank account of the customer to the bank account of the merchant.

10. The system of claim 1, wherein the received response is a first response, and the processor is further configured to:
receive, from the customer, a second response to the payment request, wherein the second response indicates a cancellation of the payment request; and
send, to a merchant server associated with the merchant, an instruction to stop fulfilling the commercial transaction between the merchant and the customer.

11. A computer-implemented method for making a payment, comprising:
receiving, by an application program interface (API) operated by a processor, a peer-to-peer (P2P) payment identification of a customer, wherein the P2P payment identification of the customer identifies the customer in a P2P payment system;
determining a customer-facing merchant identification to identify a merchant to the customer, wherein the customer-facing merchant identification is different from a P2P payment identification of the merchant that identifies the merchant in the P2P payment system;
generating a payment request to initiate a payment over the P2P payment system from the customer to the merchant for a commercial transaction between the merchant and the customer, wherein the payment request includes the customer-facing merchant identification, and an amount to be paid from the customer to the merchant;
sending the payment request to a customer device associated with the P2P payment identification of the customer;
receiving, from the customer device, a response to the payment request, wherein the response indicates an approval of the payment request by the customer; and
sending to the P2P payment system, an instruction to fulfill the payment to the merchant from the customer, wherein the instruction includes the approval of the payment request, the P2P payment identification of the merchant, and the P2P payment identification of the customer.

12. The computer-implemented method of claim 11, wherein the P2P payment identification of the customer is associated with a bank account of the customer, the P2P payment identification of the merchant is associated with a bank account of the merchant, and the P2P payment system, upon receiving the instruction to fulfill the payment, communicates with an Automated Clearing House (ACH) payment system to transfer funds from the bank account of the customer to the bank account of the merchant.

13. The computer-implemented method of claim 11, further comprising:
tracking a status of the payment request; and
determining, based on the status of the payment request, a status of the commercial transaction between the merchant and the customer.

14. The computer-implemented method of claim 11, wherein the P2P payment identification of the customer is received in response to a request made by a merchant server during a shopping flow by the customer.

15. The computer-implemented method of claim 14, wherein the P2P payment identification of the customer is submitted at a checkout time of an online shopping activity by the customer.

16. The computer-implemented method of claim 11, wherein the P2P payment identification of the customer is received from a QR code.

17. The computer-implemented method of claim 11, wherein the P2P payment identification of the customer includes an email address or a telephone number of the customer.

18. The computer-implemented method of claim 11, wherein the customer-facing merchant identification includes a name of the merchant or a logo of the merchant to identify the merchant to the customer.

19. A non-transitory computer-readable device having instructions stored thereon that, when executed by at least one computing device, cause the at least one computing device to perform operations comprising:
receiving a peer-to-peer (P2P) payment identification of a customer, wherein the P2P payment identification of the customer identifies the customer in a P2P payment system;
generating a payment request to initiate a payment over the P2P payment system from the customer to a merchant for a commercial transaction between the merchant and the customer, wherein the payment request includes a customer-facing merchant identification to identify the merchant to the customer, and an amount to be paid from the customer to the merchant;
sending the payment request to the customer through a communication channel associated with the P2P payment identification of the customer;
receiving, from the customer, a response to the payment request, wherein the response indicates an approval of the payment request; and
sending, to the P2P payment system, an instruction to fulfill the payment to the merchant from the customer, wherein the instruction includes the approval of the payment request, a P2P payment identification of the merchant, and the P2P payment identification of the customer, wherein the P2P payment identification of the merchant identifies the merchant in the P2P payment system.

20. The non-transitory computer-readable device of claim 19, wherein the P2P payment identification of the customer includes an email address or a telephone number of the customer, and wherein the customer-facing merchant identification includes a name of the merchant or a logo of the merchant to identify the merchant to the customer.
